(19) United States
(12) Patent Application Publication
(10) Pub. No.: US 2007/0296667 A1
(43) Pub. Date: Dec. 27, 2007

(54) DRIVING DEVICE AND DRIVING METHOD OF PLASMA DISPLAY PANEL

(76) Inventors: Chun-Lun Pan, Tainan City (TW); Chun-Hsu Lin, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,127

(22) Filed: Jun. 26, 2006

(51) Int. Cl. G09G 3/36

(52) U.S. Cl. 345/89

(57) ABSTRACT

A driving device of a plasma display panel including a gray level arrangement unit, a still frame detection unit and a gray level arrangement controller is provided. The gray level arrangement unit receives image data and arranges the image data according to different gray level arrangement rules. The still frame detection unit detects whether the image data is a still frame. The gray level arrangement controller is electrically connected to the still frame detection unit and the gray level arrangement unit, and controls the gray level arrangement unit to output the image data with different gray level arrangements according to whether the image data is a still frame or not. A driving method of a plasma display panel is also provided.

### BACKGROUND OF THE INVENTION

1. Field of Invention

The present invention relates to a driving device and a driving method of a display panel, and more particularly, to a driving device and a driving method of a plasma display panel.

2. Description of Related Art

The light emitting principle of a conventional plasma display is that a voltage is first applied to electrodes, and then the fluorescent on the partition wall is excited by the ultraviolet emitted from the gas, thereby emitting visible light which can be viewed by human eyes. The light emitting process is mainly controlled by three kinds of electrodes: the sustain electrode, the scan electrode, and the address electrode. The scan electrode and the address electrode are used to generate wall charges, and the scan electrode and the sustain electrode excite the gas to continuously emit light in a manner of alternating current.

FIG. 1 is a schematic diagram of a gray level of a conventional plasma display. The light emitting of the plasma display can be divided into three cycles: the reset cycle (indicated by an oblique line row from top-left to bottom-right), the address cycle (indicated by an oblique line from top-left to bottom-right), and the sustain cycle (indicated by an oblique line row from top-right to bottom-left). At first, the states of the wall charges are completely updated in the reset cycle. Then, each address electrode and each scan electrode connected to the data line are sequentially determined whether or not to generate wall charges in the corresponding sub-pixels (i.e., so called “addressing”) in the address cycle. Then, an alternating voltage is applied to the scan electrode and the sustain electrode in the sustain cycle, such that each addressed sub-pixel can emit light. To display gray levels with different luminance, the frame period is generally divided into several subfields SF0, SF1, . . . SF8 (each subfield has a sustain cycle with a different time period), and then each sub-pixel may have a different gray level by determining the address state of each sub-pixel in each subfield SF0-SF8 respectively (i.e., determining whether to emit or not in the corresponding subfield period). As shown in FIG. 1, the sustain cycles of each subfield SF0-SF8 are obviously different, which is equivalent to give light-emitting weight values 1, 1, 2, 4, 8, 16, 32, 64, 128 to the nine subfields respectively.

For example, when it is desired that a certain sub-pixel displays a gray level of 127, the sub-pixel can be addressed in the subfields SF1-SF7 for emitting light, and the sub-pixel is not addressed in the subfields SF0, SF8 (therefore, not emitting lights). Therefore, the average luminance of the sub-pixel in a frame period is gray level of 127. The light-emitting weight value of the sub-pixel can be summed up as 0+1+2+4+8+16+32+64+0=127 by way of mathematics. To display a gray level of 128, the sub-pixel is made not to emit light in the subfields SF0-SF7, but in the subfield SF8, that is, its light-emitting weight value is 0+0+0+0+0+0+0+0+128=128. However, when the method is used to process a non-static image, a dynamic false contour will generate due to the focus of visual center for human being. When the non-static image is viewed, for example, moving from the luminance 128 to luminance 127, an illusion that the sub-pixel does not emit light in all subfields SF0-SF8 occurs. The dynamic false contour may occur at other luminance, influencing the display of the non-static image significantly. For example, when a picture of a moving face is displayed, blemishes such as black lines will appear on the cheeks.

FIG. 2 is a display picture for solving the dynamic false contour. When processing the non-still frame, two different gray level arrangement rules A, B are indicated. FIG. 2 shows a frame arranged by using the gray level arrangement rules A, B. The gray level arrangement rules A, B have different subfield distributions at a same luminance. For example, when some sub-pixel is desirous to display a gray level 32, the gray level arrangement rule A enables the sub-pixel to emit light in the subfield SF6 (i.e., the light-emitting weight value as 0+0+0+0+0+0+32+0+0=32), while the gray level arrangement rule B enables the sub-pixel to emit light in the subfields SF0-SF5 (i.e., the light-emitting weight value as 1+1+2+4+8+16+0+0+0=32). In any case, the gray level arrangement rules A, B both can enable the sub-pixel to display the gray level 32.

The display frame employs an AB phase algorithm, arranging the frame by way of multiple interleaving the gray level arrangement rules A, B at space and time, such that an effect of an uniform distribution of the visual center is achieved. For the distribution of time, taking the first row as an example, the first row of a frame T201 is B, A, B, A, B, A, B, A, B, A from left to right; the first row of a next frame T202 is A, B, A, B, A, B, A, B, A, B from left to right. Then, the first row of a further next frame T203 is B, A, B, A, B, A, B, A, B, A from left to right; the first row of a further next frame T204 is A, B, A, B, A, B, A, B, A, B from left to right. A result of an interleaved time distribution becomes apparent.

The distribution of space can refer to the frame T204, taking the first to second rows of the frame T204 as an example, the first row is A, B, A, B, A, B, A, B, A, B from left to right, while the second row is B, A, B, A, B, A, B, A, B, A from left to right. The result of an interleaved space distribution becomes apparent. In this way, the human being's visual center can be dispersed, and accordingly the dynamic false contour can be diminished. However, when displaying a still frame with low gray level luminance, two different kinds of gray level luminance are switched over, such that the interval between two lighting times should be more than one frame under some luminance. According to the light-emitting property of the plasma display, the longer the interval between two lighting is, the harder the same pixel cell can be lit up, and therefore an extinction problem occurs. As the plasma display should have a function for displaying both non-static and still frames, a method is required to achieve excellent display effects for both the non-still frame and the still frame.

### SUMMARY OF THE INVENTION

An object of the present invention is to provide a driving device of a plasma display panel, which not only prevents a dynamic false contour in a non-still frame of a plasma display panel, but also prevents an extinction problem in a still frame of the plasma display panel.

Another object of the present invention is to provide a driving method of a plasma display panel, such that the problems of dynamic false contour and extinction can be prevented for the plasma display picture for the non-still frame and the still frame.

Based on the above and other objects, the present invention provides a driving device of a plasma display panel. The device includes a gray level arrangement unit, a still frame detection unit, and a gray level arrangement controller. The gray level arrangement unit receives an image data, and converts the image data to a first subfield data and a second subfield data according to different gray level arrangement rules. However, the converted subfield data is not limited to two. The still frame detection unit is used to detect whether the image data is still frame or not. The gray level arrangement controller, which is electrically connected to the still frame detection unit and the gray level arrangement unit, is used to control the manner of arranging the image gray level. When the image data is a non-still frame, the gray level arrangement controller controls the gray level arrangement unit to output the first subfield data and the second subfield data alternatively according to different positions of the frame space and different timings of the frame. When the image data is a still frame, the gray level arrangement controller controls the gray level arrangement unit to output the first subfield data and the second subfield data alternatively only according to the different positions of the frame space.

According to a preferred embodiment of the present invention, the driving device of a plasma display panel further includes a data sorting unit and a data driver. The data sorting unit electrically connected to the gray level arrangement unit is used to sort out and output the subfield data outputted by the gray level arrangement unit according to the sequence of several different subfields. The data driver electrically connected to the data sorting unit is used to drive the plasma display panel according to the output of the data sorting unit.

From another point of view, the present invention provides a driving method of a plasma display panel, which is used for providing subfield data so as to drive a plasma display panel. The method includes the following steps: converting the image data to the first subfield data and the second subfield data at least according to different gray level arrangement rules; then, detecting whether or not the image data is a still frame, and when the image data is a non-still frame, providing the first subfield data and the second subfield data alternatively according to the frame space and the frame timing, thereby driving the plasma display panel, whereas when the image data is a still frame, providing the first subfield data and the second subfield data alternatively only referencing the frame space, thereby driving the plasma display panel.

As the present invention employs a structure for driving the non-still frame and still frame through different manners, the dynamic false contour can be prevented for the non-still frame of the plasma display panel, and the extinction problem can further be prevented for the still frame of the plasma display panel.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a gray level luminance generated by a conventional plasma display.

FIG. 2 is a display picture for solving dynamic false contour.

FIG. 3 is a circuit block diagram of a driving device of a plasma display panel according to an embodiment of the present invention.

FIG. 4A is a timing diagram for the driving device of a plasma display panel to display a non-still frame according to the embodiment of the present invention.

FIG. 4B is a timing diagram for the driving device of a plasma display panel to display a still frame according to the embodiment of the present invention.

FIG. 5 is a circuit block diagram of an embodiment of a still frame detection unit 32 of FIG. 3.

FIG. 6 is a divisional diagram of the frame when determining whether the image data is a still frame or not.

FIG. 7 is a flowchart of a driving method of a plasma display panel according to an embodiment of the present invention.

FIG. 8 is a flowchart of detecting the image data (Step 720) in FIG. 7 according to an embodiment of the present invention.

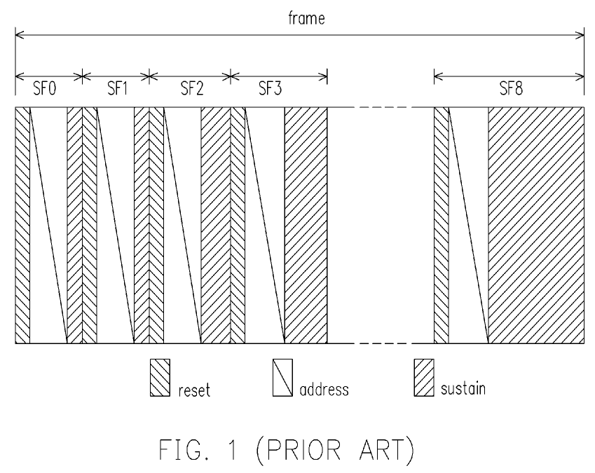

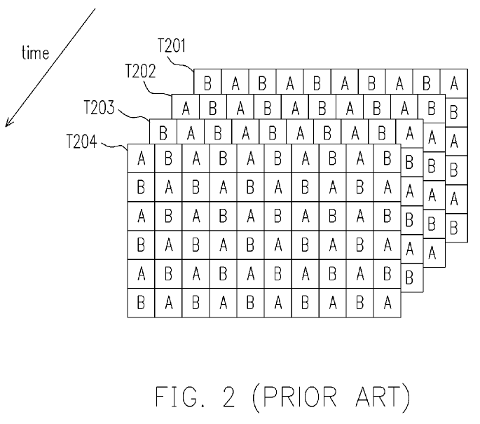

### DESCRIPTION OF EMBODIMENTS

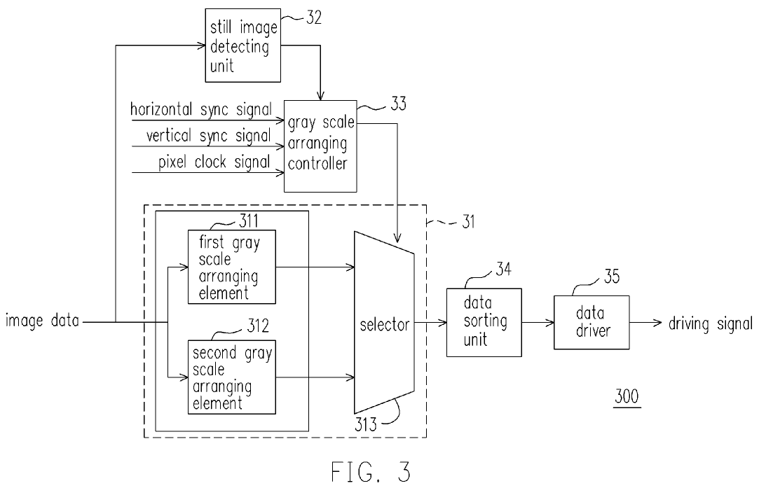

FIG. 3 is a circuit block diagram of a driving device 300 of a plasma display panel according to an embodiment of the present invention. The driving device 300 of a plasma display panel includes a gray level arrangement unit 31, a still frame detection unit 32, a gray level arrangement controller 33, a data sorting unit 34, and a data driver 35. The gray level arrangement unit 31 receives the image data, and converts the image data to a first subfield data and a second subfield data according to the gray level arrangement rules A, B.

In this embodiment, the gray level arrangement unit 31 includes a first gray level arrangement device 311, a second gray level arrangement device 312, and a selector 313. The first gray level arrangement device 311 converts the received image data into the first subfield data according to the first gray level arrangement rule A, wherein the first gray level arrangement rule A is an A phase algorithm in this embodiment. The second gray level arrangement device 312 converts the received image data into the second subfield data according to the second gray level arrangement rule B different from the first gray level arrangement rule A, wherein the second gray level arrangement rule B is a B phase algorithm in this embodiment. The selector 313 electrically connected to the first gray level arrangement device 311, the second gray level arrangement device 312, and the gray level arrangement controller 33 is used to output the first subfield data or the second subfield data selectively according to the controlling of the gray level arrangement controller 33.

The still frame detection unit 32 is used to detect whether the image data is a still frame. The gray level arrangement controller 33 is electrically connected to the still frame detection unit 32 and the gray level arrangement unit 31. The gray level arrangement controller 33 receives a horizontal synchronization signal, a vertical synchronization signal, a pixel clock signal, and a still frame detecting signal, and controls the gray level arrangement unit 31 to output the subfield data with different arrangements. When the image data is a non-still frame, the gray level control unit 33 controls the gray level arrangement unit 31 to output the first subfield data and the second subfield data alternatively according to the frame space and the frame timing. When the image data is a still frame, the gray level control unit 33 controls the gray level arrangement unit 31 to output the first subfield data and the second subfield data alternatively only referencing the frame space.

The data sorting unit 34 electrically connected to the gray level arrangement unit 31 is used to sort out and output the subfield data outputted by the gray level arrangement unit 31 according to the sequence of the subfields. The data driver 35 electrically connected to the data sorting unit 34 is used to drive the plasma display panel (not shown) according to the driving signal outputted by the data sorting unit 34. As shown in FIG. 3, the driving device of a plasma display panel of this embodiment can output the corresponding different subfield data according to whether the inputted image data is a still frame or not, thus achieving excellent display effects.

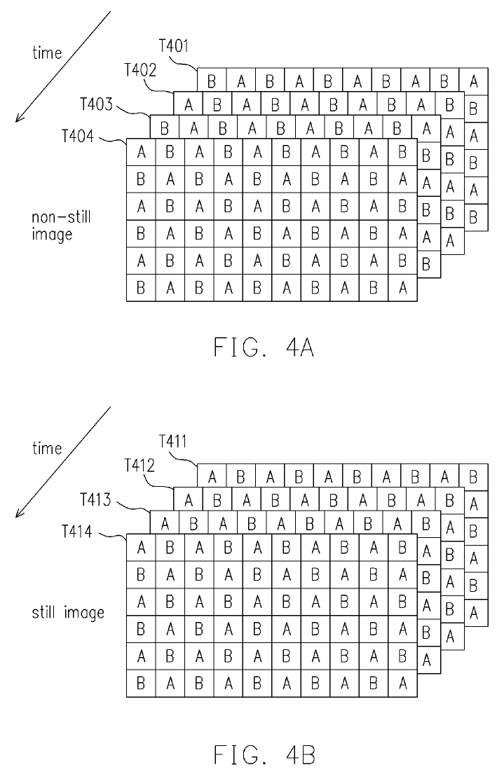

FIG. 4A is a timing diagram of the driving device of a plasma display panel to display a non-still frame according to an embodiment of the present invention. Referring to FIGS. 4A and 3, when the still frame detection unit 32 determines that the image signal is a non-still frame, the gray level arrangement unit 31 outputs the subfield data which change along with the timing and the space. The display panel can be divided into blocks with interleaved A and B as shown in FIG. 4A. The blocks with character A indicate the subfield data generated according to the first gray level arrangement rule A (i.e., A phase algorithm), while the blocks with character B indicate the subfield data generated according to the second gray level arrangement rule B (i.e., B phase algorithm). The frames T401 to T404 are display pictures when receiving non-still frames. At first, the first row of the frame T401 is arranged as B, A, B, A, B, A, B, A, B, A. Then, the first row of the next frame T402 is arranged as A, B, A, B, A, B, A, B, A, B. The first row of the further next frame T403 is arranged as B, A, B, A, B, A, B, A, B, A. Then, the first row of the next frame T404 is arranged as A, B, A, B, A, B, A, B, A, B. As known from the first rows of the frames T401-T404, the outputted subfield data are outputted alternatively according to the frame timing. The changes of other frames according to the timing can be derived through the same way. The first row of the frame T404 is A, B, A, B, A, B, A, B, A, B, and the second row of the frame T404 is B, A, B, A, B, A, B, A, B, A. It can be known that the outputted subfield data are alternatively outputted according to the frame space. The changes of other rows of the frames T401-T404 according to the space can be derived through the same way. As the subfield data changes according to the frame space and the frame timing, the human being's visual center can be balanced, thereby reducing the dynamic false contour effectively.

FIG. 4B is a timing diagram of the driving device of a plasma display panel to display a still frame according to an embodiment of the present invention. Referring to FIGS. 4B and 3, when the still frame detection unit 32 determines that the image signal is a still frame, the gray level arrangement unit 31 will output the subfield data which only changes with the space. The frames T411 to T414 are display pictures when receiving still frames. At first, the first row of the frame T411 is A, B, A, B, A, B, A, B, A, B. The first row of the next frame T412 is A, B, A, B, A, B, A, B, A, B. The first rows of the next frame T413 and a further next frame T414 are both A, B, A, B, A, B, A, B, A, B, and other frames can be derived through the same way. As shown in FIG. 4B, the outputted subfield data is not influenced by the frame timing. For the frame T414, the first row of the frame T414 is A, B, A, B, A, B, A, B, A, B; the second row is B, A, B, A, B, A, B, A, B, A, so it can be known that the outputted subfield data are alternatively outputted according to the frame space. As the manner of arranging the gray level is not changed alternatively according to the frame timing when the still frame is displayed, the extinction problem that occurred when the still frame is displayed can be reduced effectively.

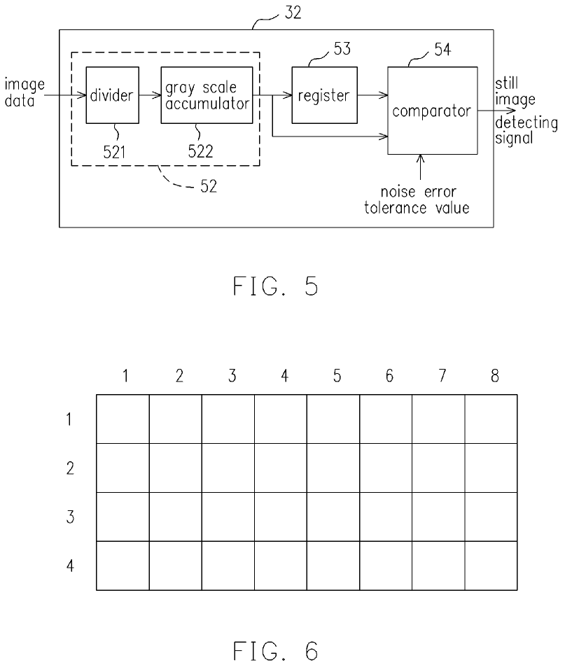

FIG. 5 is a circuit block diagram of an embodiment of the still frame detection unit 32 of FIG. 3. The still frame detection unit 32 receives an image signal, and then outputs a still frame detecting signal after the image signal is detected by the internal means. The still frame detection unit 32 includes a frame gray level calculating unit 52, a register 53, and a comparator 54. The frame gray level calculating unit 52 is used to calculate the image data of the current frame and output the calculating results of the current frame. In this embodiment, the frame gray level calculating unit 52 includes a divider 521 and a gray level accumulator 522, wherein the divider 521 is used to divide the image data of the current frame into several sub-regions, and the gray level accumulator 522 electrically connected to the divider 521 is used to accumulate the gray level values of each pixel in each sub-region, so as to output the total value of the gray level of the sub-regions as a gray level calculating result of the current frame. The register 53 electrically connected to the frame gray level calculating unit 52 is used to store the gray level calculating result of the current frame, and to provide a gray level calculating result of the previous frame. The comparator 54 electrically connected to the frame gray level calculating unit 52 and the register 53 is used to compare the gray level calculating result of the current frame with that of the previous frame to determine the image data of the current frame so as to output the still frame detecting signal. The comparator 54 also receives a noise error tolerance value as a reference for determining the still frame. Since the inputted image data contains noises, the inputted image data is determined as a non-still frame only after its variation value exceeds a certain boundary.

FIG. 6 is a divisional diagram of the frame when determining whether the image data is a still frame or not. Referring to FIGS. 5 and 6, the frame displayed by the image data can be divided into 8 columns and 4 rows by the divider 521, thus forming 8*4=32 blocks. In the 32 blocks, the gray level accumulator 522 is used to sum up the gray level values of each block respectively, and to store the total value of the gray levels for each block (i.e., the gray level calculating result) into the register 53. Meanwhile, the comparator 54 compares the total value of the gray level of each block in the pervious frame temporarily stored in the register 53 with that of the corresponding block in the current frame respectively. If the difference between the total value of the gray level of any block and that of the corresponding block in the previous frame reaches a predetermined threshold value (for example, larger than 2%), a non-still frame is determined; whereas, if the difference is not larger than 2%, a still frame is determined. The difference with the previous frame can be adjusted by the noise error tolerance value, so as to prevent the image data from being disturbed by, for example, the transmission medium difference, the external signal source, and the noise signal generated when converting the interface.

The driving device of a plasma display panel of this embodiment outputs different corresponding subfield data according to whether or not the image data is a still frame, so as to avoid dynamic false contour and the extinction problem. It should be appreciated by those skilled in the art that, the present invention is not limited to output the subfield data according to two subfield arrangement rules, but can output the subfield data according to more than two subfield rules at different frame timings and different frame spatial positions. Furthermore, the frame is not limited to be divided into 32 blocks, but can be optionally divided into any number of blocks, and the noise error tolerance value also can be adjusted to achieve preferred display effects depending on different image data.

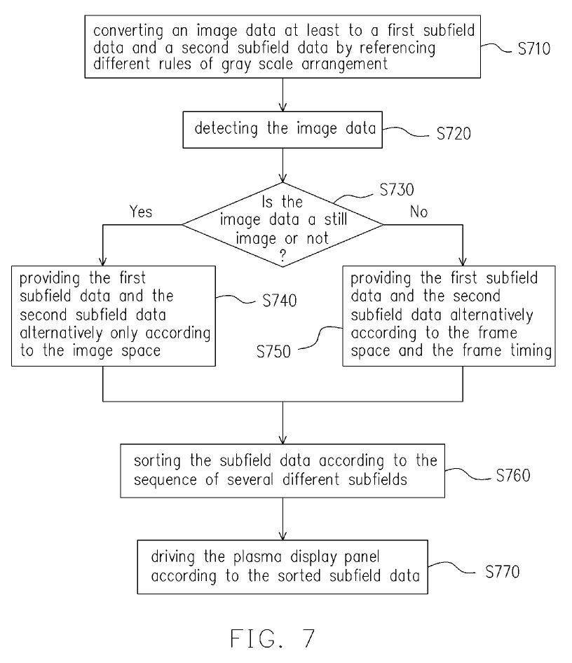

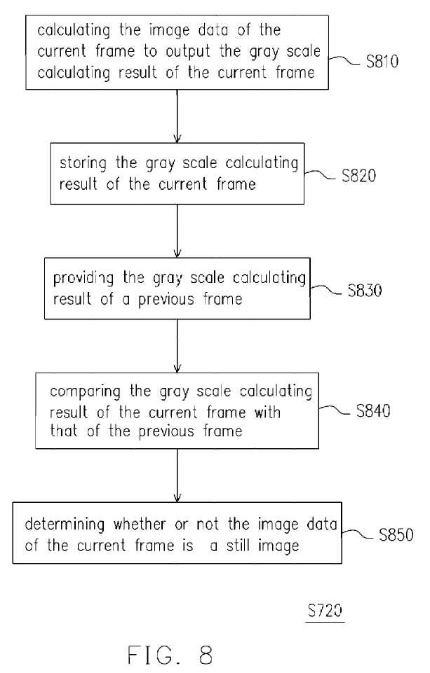

FIG. 7 is a flowchart of a driving method of a plasma display panel according to an embodiment of the present invention. Refer to FIGS. 3 and 7, each step of the driving method of this embodiment can be understood. At first, the gray level arrangement unit 31 converts the image data into at least a first subfield data and a second subfield data according to different arrangement rules (Step 710). In this embodiment, the first gray level arrangement device 311 converts the image data into the first subfield data according to the first gray level arrangement rule, and the second gray level arrangement device 312 converts the image data into the second subfield data according to the second gray level arrangement rule (different from the first gray level arrangement rule) in Step 710.

Then, the still frame detection unit 32 detects the image data (Step 720), and determines whether the image data is a still frame or not (Step 730). When the still frame detection unit 32 determines that the image data is a non-still frame, the gray level arrangement unit 31 controls the selector 313 to provide the first subfield data and the second subfield data alternatively according to the frame space and the frame timing (Step 750). When the image data is a still frame, the gray level arrangement unit 31 controls the selector 313 to provide the first subfield data and the second subfield data alternatively only according to the frame space (Step 740).

The sorting unit 34 sorts out the subfield data according to the sequence of several different subfields (Step 760). The data driver 35 then drives the plasma display panel according to the sorted subfield data (Step 770). The method of this embodiment can be used to output different subfield data according to whether the image data is a still frame, such that the plasma display panel can achieve excellent display effects when displaying the image data.

FIG. 8 is a flowchart of detecting the image data (Step 720) in FIG. 7 according to an embodiment of the present invention. Referring to FIGS. 5 and 8, the frame gray level calculating unit 52 calculates the image data of the current frame to output the gray level calculating result of the current frame (Step 810). In this embodiment, Step 810 includes the following processes: the divider 521 divides the image data of the current frame into several sub-regions; then, the gray level accumulator 522 accumulates the gray level value of each pixel in each sub-region to output the total value of the gray level of the sub-regions as the gray level calculating result of the current frame.

The register 53 stores the gray level calculating result of the current frame (Step 820) and provides the gray level calculating result of the previous frame (Step 830). Then, the comparator 54 compares the gray level calculating result of the current frame with that of the previous frame (Step 840) to determine whether the image data of the current frame is a still frame or not (Step 850). It should be appreciated by those skilled in the art that the image data is not limited to be converted into the first subfield data and the second subfield data in the present invention, but the image data can be optionally converted into more than two subfield data to achieve preferred display effects.

In summary, the driving device of a plasma display panel and method thereof according to the present invention employ the way of outputting different subfield data according to the static or non-still frame, so as to avoid the extinction problem for the still frame, and to further solve the problem of dynamic false contour for the non-still frame.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving device of a plasma display panel, comprising:
a gray level arrangement unit, for receiving an image data, and converting the image data into at least a first subfield data and a second subfield data according to different gray level arrangement rules;
a still frame detection unit, suitable for detecting whether the image data is a still frame or not; and
a gray level arrangement controller, electrically connected to the still frame detection unit and the gray level arrangement unit, wherein the gray level arrangement controller is suitable for controlling the gray level arrangement unit to output the first subfield data and the second subfield data alternatively according to a frame space and a frame timing when the image data is a non-still frame, and controlling the gray level arrangement unit to output the first subfield data and the second subfield data alternatively only according to the frame space when the image data is a still frame.

2. The driving device of a plasma display panel as claimed in claim 1, wherein the gray level arrangement unit comprises:
a first gray level arrangement device, converting the received image data into the first subfield data according to a first gray level arrangement rule;
a second gray level arrangement device, converting the received image data into the second subfield data according to a second gray level arrangement rule that is different from the first gray level arrangement rule; and
a selector, electrically connected to the first gray level arrangement device, the second gray level arrangement device, and the gray level arrangement controller, wherein the selector is suitable for outputting the first subfield data or the second subfield data selectively according to the control of the gray level arrangement controller.

3. The driving device of a plasma display panel as claimed in claim 1, wherein the still frame detection unit comprises:
a frame gray level calculating unit, used for calculating the image data of a current frame to output a gray level calculating result of the current frame;
a register, electrically connected to the frame gray level calculating unit, wherein the register is suitable for storing the gray level calculating result of the current frame, and providing the gray level calculating result of a previous frame; and
a comparator, electrically connected to the frame gray level calculating unit and the register, wherein the comparator is suitable for comparing the gray level calculating result of the current frame with that of the previous frame, and determining whether the image data of the current frame is a still frame or not.

4. The driving device of a plasma display panel as claimed in claim 3, wherein the frame gray level calculating unit comprises:
a divider, used for dividing the image data of the current frame into several sub-regions; and
a gray level accumulator, electrically connected to the divider, wherein the gray level accumulator is suitable for accumulating the gray level value of each pixel in each sub-region, outputting the total value of the gray level of the sub-regions as the gray level calculating result of the current frame.

5. The driving device of a plasma display panel as claimed in claim 1, further comprising:
a data sorting unit, electrically connected to the gray level arrangement unit, used for sorting and outputting the subfield data outputted by the gray level arrangement unit according to the sequence of several different subfields; and
a data driver, electrically connected to the data sorting unit, used for driving the plasma display panel according to the output of the data sorting unit.

6. A driving method of a plasma display panel, used for providing subfield data so as to drive the plasma display panel, comprising:
converting an image data into at least a first subfield data and a second subfield data according to different gray level arrangement rules;
detecting whether the image data is a still frame;
providing the first subfield data and the second subfield data alternatively according to a frame space and a frame timing when the image data is a non-still frame, so as to drive the plasma display panel; and
providing the first subfield data and the second subfield data alternatively only according to the frame space when the image data is a still frame, so as to drive driving the plasma display panel.

7. The driving method of a plasma display panel as claimed in claim 6, wherein the step of converting the image data into the first subfield data and the second subfield data comprises:
converting the image data into the first subfield data according to a first gray level arrangement rule; and
converting the image data into the second subfield data according to a second gray level arrangement rule that is different from the first gray level arrangement rule.

8. The driving method of a plasma display panel as claimed in claim 6, wherein the step of detecting whether the image data is a still frame comprises:
calculating the image data of a current frame to output the gray level calculating result of the current frame;
storing the gray level calculating result of the current frame;
providing the gray level calculating result of a previous frame; and
comparing the gray level calculating result of the current frame with that of the previous frame to determine whether the image data of the current frame is a still frame or not.

9. The driving method of a plasma display panel as claimed in claim 8, wherein the step of calculating the image data of the current frame comprises:
dividing the image data of the current frame into several sub-regions; and
accumulating the gray level value of each pixel in each sub-region respectively to output a total value of the gray level of the sub-regions as the gray level calculating result of the current frame.

10. The driving method of a plasma display panel as claimed in claim 6, further comprising:
sorting the subfield data according to the sequence of several different subfields; and
driving the plasma display panel according to the sorted subfield data.
